(19) United States
(12) Patent Application Publication
(10) Pub. No.: US 2020/0275192 A1
(43) Pub. Date: Aug. 27, 2020

(54) Audio Strip Device

(71) Applicants: Alex Hirst, Mesa, AZ (US); Scott Hirst, Mesa, AZ (US)

(72) Inventors: Alex Hirst, Mesa, AZ (US); Scott Hirst, Mesa, AZ (US)

(21) Appl. No.: 16/797,085

(22) Filed: Feb. 21, 2020

Related U.S. Application Data
(60) Provisional application No. 62/808,561, filed on Feb. 21, 2019.

(51) Int. Cl. H04R 1/28; H04R 1/34

(52) U.S. Cl. CPC H04R 1/288; H04R 1/345

(57) ABSTRACT

An audio strip device for use with a speaker can comprise a top surface; and a bottom surface wherein the top surface and the bottom can have a thickness in the shape of a waveform and a length wherein the bottom surface can have an adhesive attached to bottom surface, front surface or sides. The waveform can have a crest and a trough with an amplitude. The audio strip device can be formed into a shape of a speaker having a joint wherein the joint can have adhesive attached to it forming a solid connection. The method of manufacturing and installing an audio strip device comprises producing a top surface, and a bottom surface from compressible material having a thickness and a length wherein the top surface through to the bottom surface can be cut into a shape of a waveform along its length. Adhesive can be applied to one of the surfaces, and the audio strip device's length can be cut to a user's desired length to fit around any size speaker.

### CROSS-REFERENCE TO RELATED APPLICATIONS

This application claims benefit from currently pending U.S. Provisional Application No. 62/808,561 titled “Acoustic Strip Device” and having a filing date of Feb. 21, 2019, all of which is incorporated by reference herein.

### TECHNICAL FIELD

The present specification relates to an audio system, more particularly an acoustic strip device for directing sound and dampening acoustic resonations.

### BACKGROUND

Various types of speaker insulation and acoustic dampeners exist within the art. Speaker systems are installed in car doors and dashboards, and in walls and ceilings of homes and studios. Speaker housings are used to support the speakers and are usually attached directly to the opposing mating surfaces such as on the inner door panel or inner surface of the wall. As the speaker's diaphragm moves sound waves are created which changes the air pressure causing different items and fixtures within the car or building to vibrate at varying frequencies. When attached directly to the opposing surface the sound waves are directed through the opposing surface, and trap and reverberate the sounds waves causing, for example, the car door or dashboard to rattle and vibrate or to create sound waves to interfere with the sound waves created by the speaker. To prevent sound distortion the sound waves coming from the speaker need to be directed into the cabin of the car or room of the building, and the high and low frequency response that cause rattling need to be dampened for clear sound.

U.S. Pat. No. 8,376,421 shows a sealing, absorbing, and decoupling speaker ring kit. The kit has an outer ring, an inner ring, and a core wherein the outer ring corresponds with the diameter of the front edge of the speaker, and the inner ring corresponds to the diameter of the rear edge of the speaker. The core corresponds to the space provided within the speaker mount. The outer ring, inner ring and core is formed out of a drum which is formed from an open-celled foam. One disadvantage of this design is that multiple sizes of drums are required to conform to different size speakers. In addition, concentric holes must be cut for the outer ring and the inner ring to form the foam to the speakers adding unneeded time and effort to dampen the vibrations coming from the speakers.

It would be advantageous to provide a sound directing, dampening material that can be fit around any size or shape of speaker that would improve acoustical response and decrease rattling and vibrations within the environment the speakers are sending the sound waves into.

### SUMMARY

Aspects disclosed herein comprise an audio strip device for use with a speaker, wherein the audio strip system comprises a top surface; and a bottom surface wherein the top surface and the bottom can have a thickness in the shape of a waveform and a length wherein the bottom surface can have an adhesive attached to bottom surface, front surface or sides. The waveform can have a crest and a trough with an amplitude. The audio strip device can be formed into a shape of a speaker having a joint wherein the joint can have adhesive attached to it forming a solid connection. The adhesive can be double-sided pressure sensitive tape. The audio strip device can be attached to a speaker and can be compressed between the speaker and its mating surface. The audio strip device thickness can be at least 5 millimeters, and the material can be a compressible material such as closed-cell or open-cell foam.

The method of manufacturing and installing an audio strip device, wherein the method of manufacturing and installing comprises producing a top surface, and a bottom surface from compressible material having a thickness and a length wherein the top surface through to the bottom surface can be cut into a shape of a waveform along its length. Adhesive can be applied to the bottom surface. The audio strip device length can be cut to the speaker's circumference, and the audio strip device can be shaped to, and attached to the speaker's basket. The speaker can be installed into a door, panel, or wall and can be compressed between the speaker's basket and the mating surface. The audio strip device can be attached to the speaker's basket by adhesive wherein the adhesive can be pressure sensitive adhesive. The waveform can be a sinusoidal wave, or in other embodiments square wave, sawtooth wave. The compressible material can be closed-cell or open-cell foam.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of molding a fishing lure, without also reciting in such phrases any structure, material or act in support of the function. Thus, even when the claims recite a “means for performing the function of molding a fishing lure, step for performing the function of molding a fishing lure,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1a is a top view of one embodiment of an audio strip system in accordance to one, or more embodiments;

FIG. 1b is a side view of one embodiment of an audio strip system in accordance to one, or more embodiments;

FIG. 1c is a bottom view of one embodiment of an audio strip system in accordance to one, or more embodiments;

FIG. 2a is an isometric view of an example installation one embodiment of an audio strip system in its off position in accordance to one, or more embodiments;

FIG. 2b is an isometric view of an example installation one embodiment of an audio strip system placed on a speaker in accordance to one, or more embodiments;

FIG. 3a is an isometric view of an example installation another embodiment of an audio strip system in its off position in accordance to one, or more embodiments;

FIG. 3b is an isometric view of an example installation another embodiment of an audio strip system placed on a speaker in accordance to one, or more embodiments;

FIG. 4a is a top view of an example shape embodiment of an audio strip device in accordance to one, or more embodiments;

FIG. 4b is a top view of another example shape an embodiment of an audio strip device in accordance to one, or more embodiments;

FIG. 4c is a top view of another example shape embodiment of an audio strip device in accordance to one, or more embodiments;

FIG. 4d is a top view of another example shape embodiment of an audio strip device in accordance to one, or more embodiments; and

FIG. 4e is a top view of another example shape embodiment of an audio strip device in accordance to one, or more embodiments.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

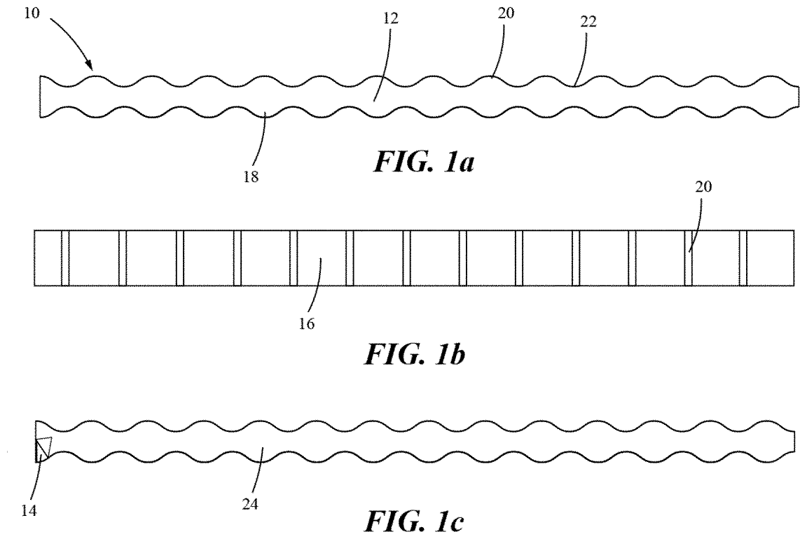

Referring to FIG. 1a-1c. a top, side, and bottom view of an audio strip device is shown generally at 10. In a preferred embodiment, an audio strip system 10 can comprise a top surface 12, a bottom surface 14 having a width that can be in the shape of a waveform 18 wherein the waveform can be uniform, or non-uniform square wave, sinusoidal wave, damped sine wave, square wave, rectangular wave, sawtooth wave, triangle wave, or the like, and sides 16 having a thickness and a length. The waveform 18 can be regular (as shown) or irregular. The waveform 18 can have a crest 20 and a trough 22 wherein the crest and trough can have a consistent amplitude or varying amplitude wherein the amplitude can be such as, for example, between 2 millimeters and 40 millimeters, more preferably an amplitude of between 10 millimeters and 20 millimeters, and still more preferably an amplitude of approximately 10 millimeters or the like. The audio strip device 10 can have a thickness of such as, for example, between 2 millimeters and 60 millimeters, more preferably a thickness of between 10 millimeters and 40 millimeters, and still more preferably a thickness of approximately 25 millimeters or the like.

An audio strip device 10 can further comprise an adhesive 24 wherein the adhesive 24 can be applied to the bottom surface 14, or in other embodiments the top surface 12, or the sides 16 of the audio strip device 10. The adhesive 24 can be a peel and stick adhesive, and can be such as, for example, pressure sensitive adhesive, heat sensitive adhesive, acrylic adhesive, polythene adhesive, polyester adhesive, or the like. The audio strip device 10 can further comprise of two ends wherein the ends can form a joint 26 wherein the adhesive can attach one or both end allowing the audio strip device to be joined together forming a complete piece able to be shaped around different size and shape speakers. In certain embodiments the adhesive can be omitted from the joint. The thickness of the audio strip device 10 can be such as, for example, between 10 millimeters and 50 millimeters, more preferably a thickness of between 15 millimeters and 30 millimeters, and still more preferably a thickness of approximately 22 millimeters or the like. The audio strip device 10 can be manufactured from materials such as, for example, rubberized closed-foam, chloroprene rubber, styrene-butadiene rubber, ethylene-propylene-diene-monomer, polystyrene, closed-cell nitrile, closed-cell neoprene, or any open-cell foam, or the like. The audio strip device 10 can be waterproof keeping the car door or panel free from water or outside environmental conditions. The material can have a density of such as, for example, between 2 pcf and 50 pcf inches, more preferably a density of between 4 pcf and 40 pcf, and still more preferably a density of approximately 15 pcf or the like.

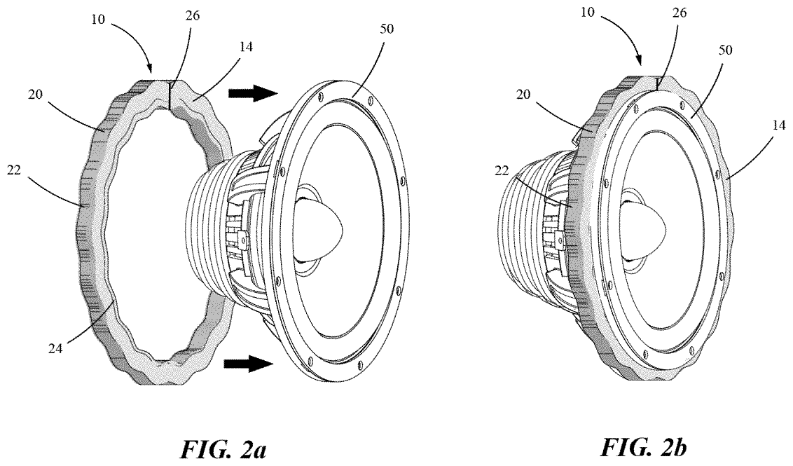

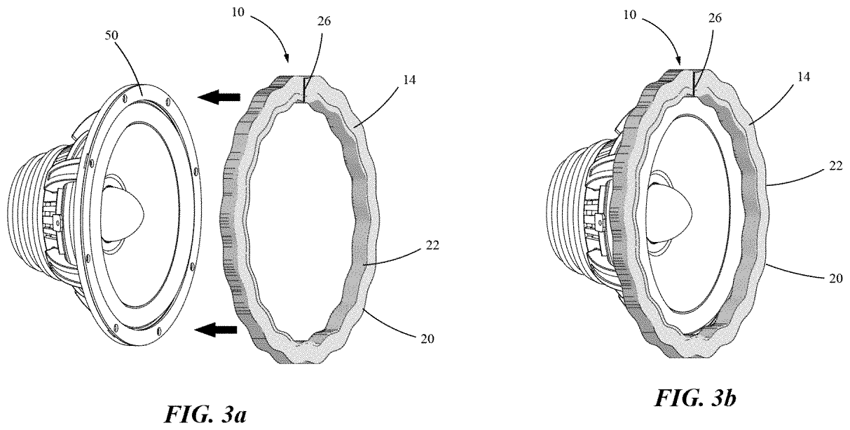

Referring to FIG. 2a-3b, an isometric view of an audio strip device 10 being attached to the back side or front side of a speaker 50. In embodiments a speaker 50 can have a basket 52 wherein the basket can be attached to a car door or panel, or onto a building's wall. The audio strip device 10 can be cut to length, and then formed around the speaker 50 at the speaker's predetermined set shape and size, and the audio strip device ends can form a joint 26 and can be joined by adhesive. The audio strip device 10 can be attached by adhesive to the back side or the front side of the speaker's basket wherein the basket can be set into and attached the car's door or panel, or building's wall wherein the audio strip device can be compressed between the car's door or panel, or building's wall. The audio strip device 10 waveform 18 having a crest 20 and a trough 22 can allow the audio strip device to be formed into any shape which allows for sharp bends or corners without compromising the integrity of the foam structure when placed around a speaker.

In some embodiments, the spacing and amplitude of the crests 20 and troughs 22 can be designed to allow for a particular minimum and/or maximum radius of curvature of the formed audio strip device 10. In addition, the thickness in the strip device 10 between troughs 22 on opposite sides of the strip may be altered for specific purposes.

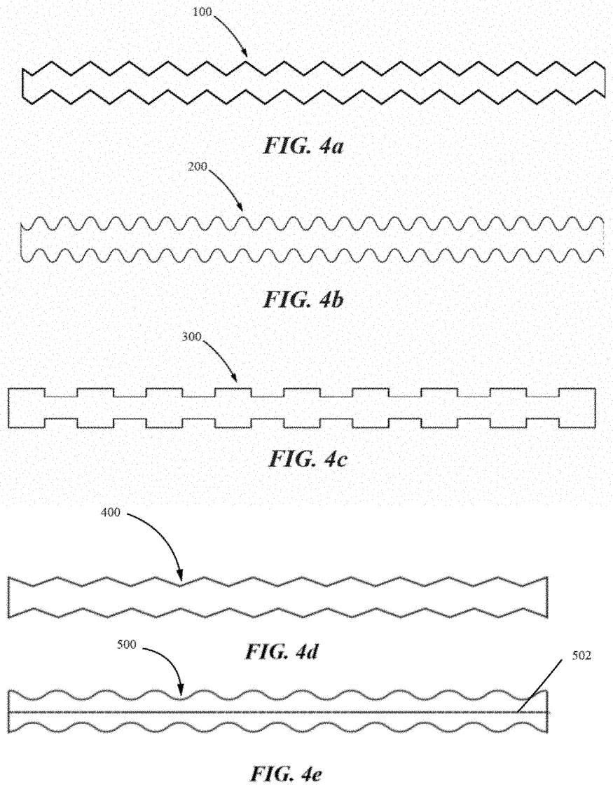

Referring to FIG. 4a-4e, shows different configurations of the audio strip system. In some embodiments, the audio strip system can be cut to form different waveforms such as, but not limited to, for example, a triangular wave 100 and 400, a sinusoidal wave 200, or a square wave 300. By having the audio strip device in the shape of a waveform the audio strip device can take on the shape of any type of speaker such as, for example, rectangular, square, circular, ovular, triangular, or the like without sacrificing the integrity of the structure, and keeping the sound directed into the cabin, or room, and dampening the resonant frequencies that may occur from the sound waves into the car or building's surroundings. The audio strip system 500 can have a perforated centerline to allow the audio strip system to be split into two separate pieces.

In some embodiments the method of manufacturing and installing an audio strip device (referring to FIG. 2a-3b for the following) can comprise producing a top surface 12, and a bottom surface from compressible material having a thickness and a length. The top surface and the bottom surface can have a thickness which can be cut into a shape of a waveform along its length. An adhesive can be applied to at least one of the top, bottom, side, and end surfaces. The length of the audio strip device can be cut to a speaker's circumference. The audio strip device can be shaped and attached to the speaker's basket, or in other embodiments to the speaker's cone. The audio strip device can be installed to the speaker and compressed between the speaker's basket and it's mating surface. The mating surface can be the door or the panel of a car, or the ceiling or wall of a building. The audio strip device can be attached by adhesive which can be dual-sided pressure sensitive tape. The waveform can be such as, but not limited to, for example, a triangular wave 100, a sinusoidal wave 200, or a square wave, and the audio strip can be made from compressible material that can be closed-cell or open-cell foam.

It is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. An audio strip system for use with a speaker, wherein the system comprises:
a strip having a top surface and a bottom surface and a thickness between the top surface and the bottom surface and wherein the strip is shaped as a waveform having a crest and a trough; and
an adhesive attached to at least a portion of the bottom surface of the strip.

2. The device of claim 1, wherein the waveform is substantially a sin wave.

3. The device of claim 1, wherein the strip has a first end and a second end and wherein at least one end has an adhesive attached to it to allow the first end to adhere to the second end.

4. The device of claim 3, wherein the strip is attached to a speaker, wherein the speaker has a basket and wherein the strip is compressed between the basket and a mating surface.

5. The device of claim 1, wherein the adhesive is double-sided pressure sensitive tape.

6. The device of claim 1, wherein the thickness is at least 5 millimeters.

7. The device of claim 1, wherein the material is a compressible material such as closed-cell or open-cell foam.

8. The method of manufacturing and installing an audio strip device on a speaker having a circumference and a basket, wherein the method of manufacturing and installing comprises:
providing a strip in the shape of a waveform from compressible material, the strip having a top surface, and a bottom surface and an adhesive applied to the bottom surface;
cutting the strip to the circumference of the speaker;
shaping and attaching the strip to the basket of the speaker;
installing the speaker and compressing the strip between the basket and a mating surface;

9. The method of claim 7, wherein the adhesive is pressure sensitive double sided tape.

10. The method of claim 7, wherein the waveform can be a sinusoidal wave.

11. The method of claim 7, wherein the compressible material is closed-cell or open-cell foam.
